(19) United States
(12) Patent Application Publication
(10) Pub. No.: US 2014/0113045 A1
(43) Pub. Date: Apr. 24, 2014

(54) APPARATUS FOR CARBONATING BEVERAGES

(71) Applicants: Starbucks Corporation d/b/a Starbucks Coffee Company, Seattle, WA (US); IMI Cornelius, Inc., Glendale Heights, IL (US)

(72) Inventors: David K. Njaastad, Palatine, IL (US); Diane D. Terry, Tacoma, WA (US); Paul N. Camera, Sammamish, WA (US)

(73) Assignees: Starbucks Corporation d/b/a Starbucks Coffee Company, Seattle, WA (US); IMI Comelius, Inc., Glendale Heights, IL (US)

(21) Appl. No.: 14/058,046

(22) Filed: Oct. 18, 2013

Related U.S. Application Data
(60) Provisional application No. 61/715,757, filed on Oct. 18, 2012.

(51) Int. Cl. B01F 3/04; A23L 2/54

(52) U.S. Cl. CPC B01F 3/04794; A23L 2/54
USPC 426/477; 261/74

(57) ABSTRACT

A device for carbonating beverages includes a gas supply compartment in pneumatic communication with a gas supply conduit and a container coupled to the gas supply compartment. The container has an opening. A gasket is coupled to the opening of the container and the gas supply compartment. The gasket has an opening through which gas flows from the gas supply compartment to the container.

This is a non-provisional patent application claiming priority to U.S. Provisional Application Ser. No. 61/715,757, filed Oct. 18, 2012, which is incorporated herein by reference in its entirety.

### BACKGROUND

1. Field of the Invention

The present application is directed to an apparatus for creating beverages and more particularly to an apparatus for carbonating beverages.

2. Description of the Related Art

Many existing producers of carbonated beverages carbonate the beverages at a manufacturing plant and subsequently ship the carbonated beverages in appropriate pressure resistant bottles, tanks or other containers to authorized distributors, retailers, and other sellers of carbonated beverages, such as grocery stores, movie theaters, concession stands, restaurants, sporting events, and other distribution facilities. The shipping and storage of pressurized bottles and containers involves the unnecessary handling of additional bulk. This requires a substantial amount of extra shipping and handling space which adds cost and introduces inefficiencies in the production of carbonated beverages for end user consumption. This practice has the additional limitation of requiring the retailer to be able to accurately estimate the demand for each type of carbonated beverage that they will sell prior to ordering and receiving a shipment from a manufacturer. The retailer is not able to adjust their supply of carbonated beverages in between shipments should their demand exceed or fall below their previously anticipated ordering quantities. Similarly, a retailer of prepackaged beverages is not able to tailor the composition of the beverage to a consumer's preference.

Another common practice is to mix various flavoring liquids with water carbonated on the premises just prior to consumption of the beverage or at the time of sale of the beverage to a consumer. In certain practices, such beverages are mixed as the beverage is dispensed into a cup, for example beverages dispensed via a commonly used fountain beverage machine. This practice calls for an installation of substantial size including compressors, tanks, and piping, which require considerable investment and space. One disadvantage of this method is that the carbonation and mixing process necessarily wastes a significant amount of carbon dioxide gas in order to facilitate introduction of the carbon dioxide gas into the mixture. A beverage produced in this manner has therefore relatively little effervescence since most of the carbon dioxide gas is expelled prior to beverage consumption. A further disadvantage is that beverages produced in this manner must necessarily contain a water base because carbon dioxide gas is introduced into the beverage solely through the medium of water.

There is therefore widespread need for an apparatus that carbonates a multi-ingredient carbonated beverage immediately before consumption by the end user. Such an apparatus would be particularly suitable for carbonating a beverage composed of several ingredients, which could be mixed and carbonated proximally in time. In this matter, a customer can be provided with a custom carbonated beverage, tailored to the customer's preferred proportions, carbonation level and ingredients.

### SUMMARY

In accordance with one embodiment, an apparatus for carbonating beverages includes a base and a gas supply compartment positioned above the base. A container is positioned between at least a portion of the base and the gas supply compartment, the container having a top with an opening and a bottom. A gasket is mounted between the top of the container and the gas supply compartment. The gasket has a funnel-like shape and an opening positioned at a narrow end of the funnel-like shape. A conduit is coupled to a gas source and the pressurization compartment. In operation, gas is supplied to the gas supply compartment, flows through the gasket and flows into the container.

In accordance with another embodiment, a device for carbonating beverages includes a pressurization compartment and a container coupled to the gas supply compartment. The container has an opening. A gasket is coupled to the opening in the container and forms a pressure tight vessel of the container and the gas supply compartment. The gasket has an opening. A gas conduit is in pneumatic communication with the pressurization compartment. In operation, gas is supplied to the gas supply compartment, flows through the gasket and flows into the container.

In accordance with another embodiment, a method of carbonating a beverage comprises filling a container with a liquid, placing a gasket on an opening of the container, coupling the container and gasket to a gas supply compartment of a carbonation device; and actuating the carbonation device to supply gas into the gas supply compartment, which then flows through the gasket and into the container.

In accordance with another embodiment, a method of carbonating a beverage comprises filling a container with a liquid, placing a gasket between an opening of the container and a gas supply compartment of a carbonation device, and supplying gas into the gas supply compartment and through the gasket and into the container.

In accordance with another embodiment, a method of carbonating a beverage comprises shaking a container comprising a plurality of ingredients while carbon dioxide gas is supplied through an opening in a gasket positioned on an opening of the container.

In accordance with one embodiment, the base has a platform upon which the container support is situated and is movably coupled with the platform to vigorously mix the ingredients in the container. The container support may be agitated to induce mixing of the container's ingredients by oscillating in a transverse direction relative to the top of the platform, oscillating in parallel direction relative to the top of the platform, oscillating at an oblique direction relative to the top of the platform, and gyrating or rotating on its axis.

In furtherance of one arrangement of the above embodiment, the container has a hollow body shape with an open top end and a bottom. The gasket couples the container to the gas supply compartment and a lid by a container mount. In one embodiment, the gasket may be comprised of a flexible membrane, polymeric material, or elastomeric material that is removably secured to the lid within the compartment during pressurization. The gasket has a circumference, proximate to which it mates to the open top end in the container. The gasket has a frustroconical protrusion having a hole through which gas flows from a gas supply compartment into the container. The gasket has a relaxed state and an inverted state, both of which are characterized by the position of the frustroconical protrusion. The gasket is placed on top of the container in its relaxed state with at least a portion of the gasket extending downwardly into the opening of the container. During operation, a portion of the gasket may be moved into the inverted state directed away from the opening of the container when gas is supplied into the container.

### BRIEF DESCRIPTION OF THE DRAWINGS

FIG. 1 is a front perspective view of an embodiment of a carbonation device with a cover in an open position

FIG. 2 is a front perspective view of the device of FIG. 1 with a container positioned on the device.

FIG. 3 is a front perspective view of the device of FIG. 1 with the cover in a closed position.

FIG. 4 is a front perspective view of the device of FIG. 1 with the cover in an open position, a gasket positioned on a lid and container mount in an open position.

FIG. 5 is a front view of another embodiment of a carbonation device.

FIG. 6 is a front perspective view of the container shown in FIG. 2.

FIG. 7 is a cross sectional view of the device of FIG. 2, taken at line A-A.

FIG. 8 is a side perspective view of the gasket shown in FIG. 4.

FIG. 9 is a side view of the gasket shown in FIG. 8.

FIG. 10 is a top view of the gasket of FIG. 8.

FIG. 11 is a bottom view of the gasket of FIG. 8.

FIG. 12 shows a schematic drawing of a motor control device for an embodiment of a carbonation device.

### DETAILED DESCRIPTION OF THE PREFERRED EMBODIMENTS

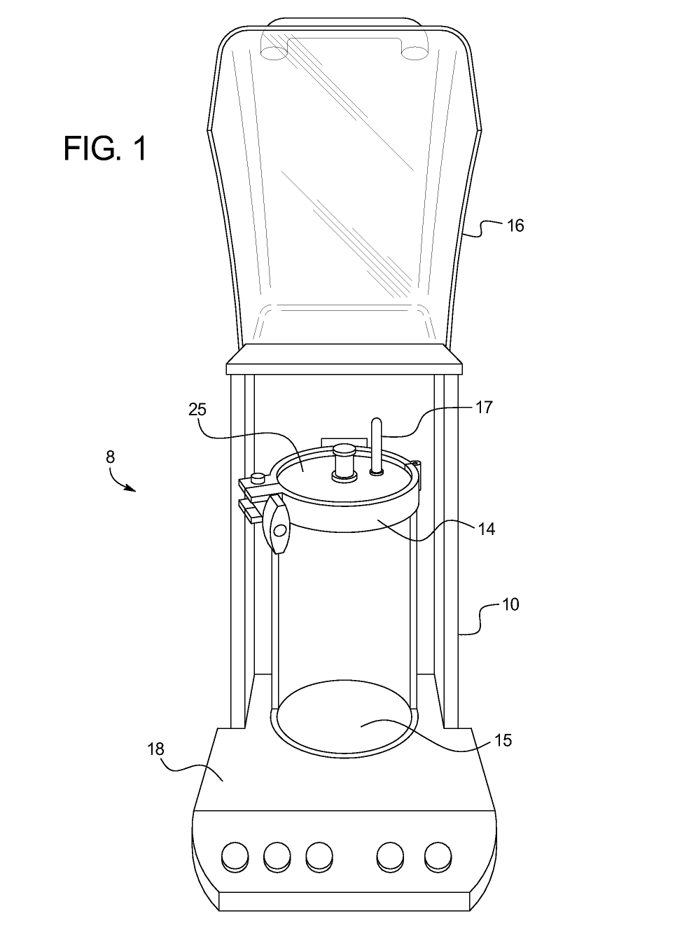

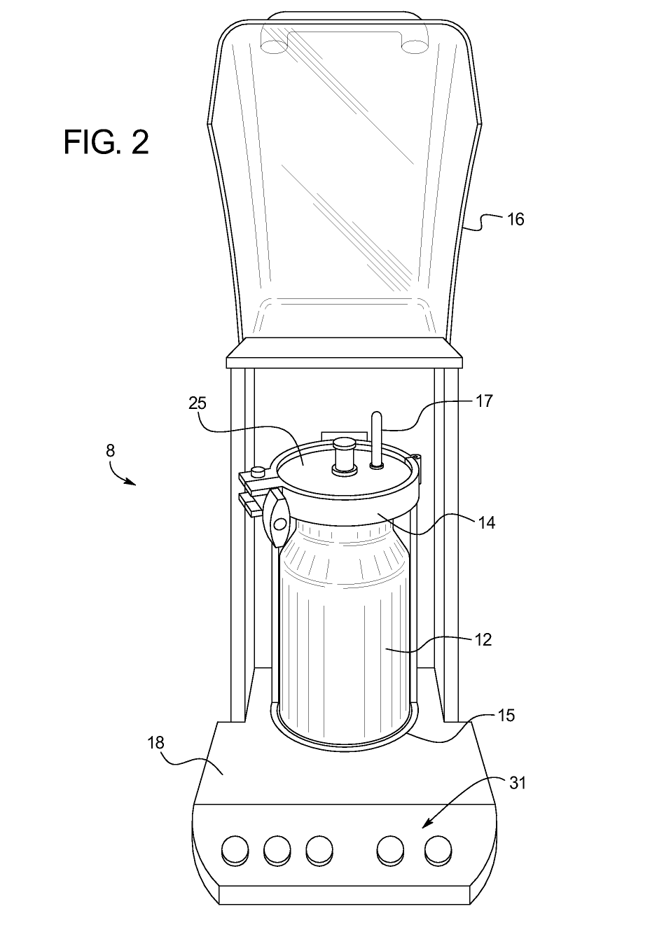

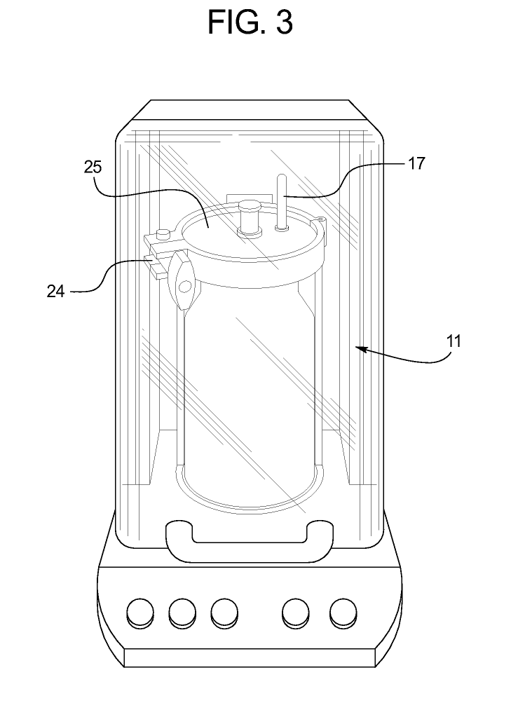

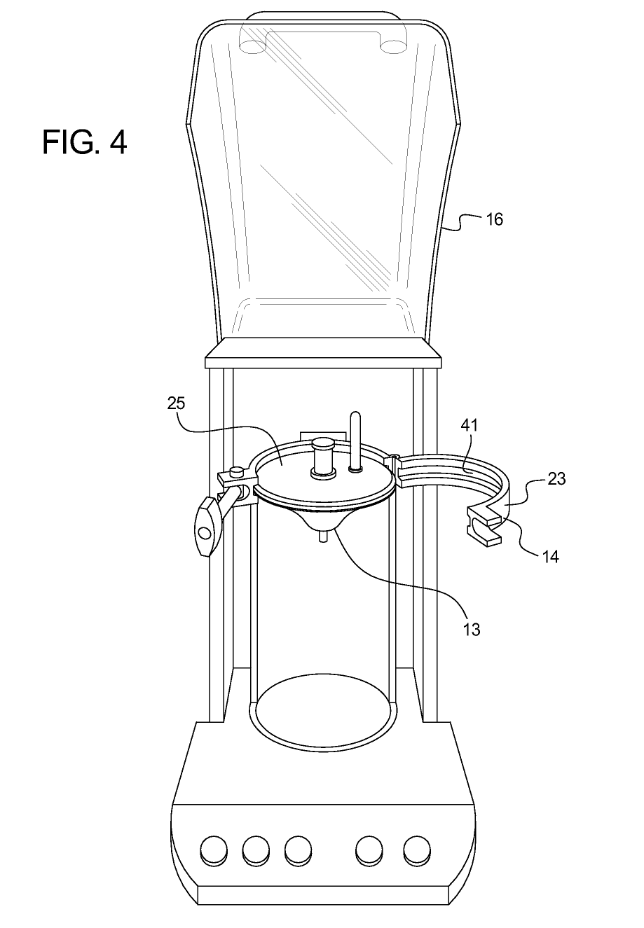

One embodiment described herein includes an apparatus and method for carbonating and mixing a carbonated beverage with several ingredients, potentially including water, syrups, flavoring, juice and other additives, which can be mixed and carbonated proximally in time. FIGS. 1 and 2 illustrate one arrangement of such a carbonation device 8. In the illustrated arrangement, the carbonation device 8 includes a base 10, a container 12, and a gasket 13 (shown in FIG. 4). The device 8 also includes a container mount 14, a container support 15, a cover 16, and a gas delivery conduit 17 as shown in FIGS. 2 and 3.

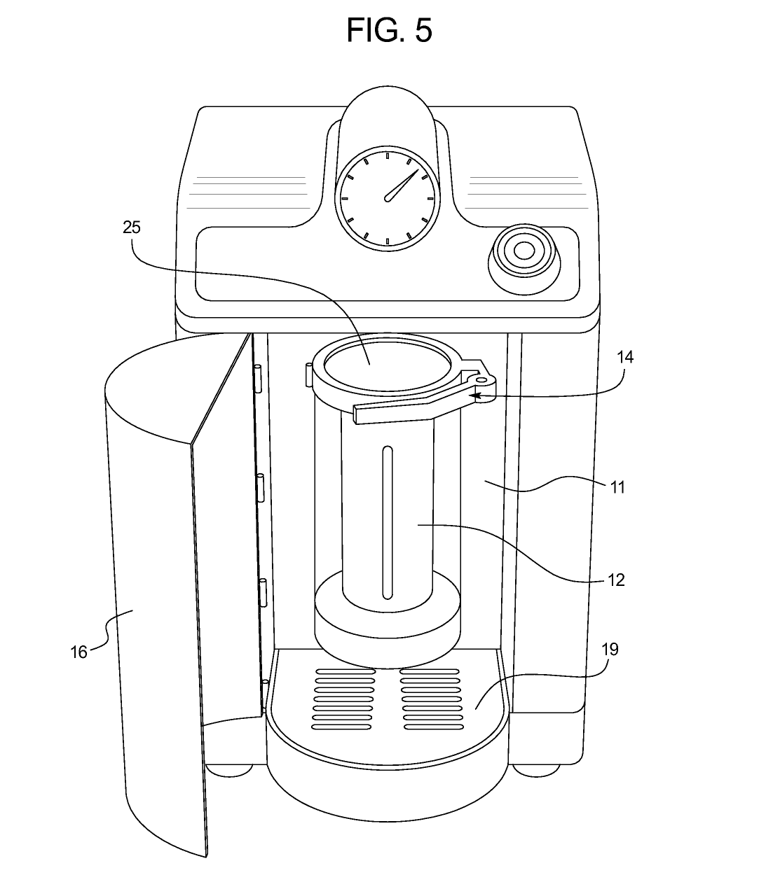

With reference to the embodiment in FIGS. 1, 2, and 4, the base 10 includes a platform 18 above which is mounted the container support 15. The platform 18 can provide a seat for the container 12. The container 12 can be easily removed or placed on the seat by hand. FIG. 5 shows a different embodiment wherein the platform 18 has a perforated top surface 19 which can include, in one arrangement, a storage tray underneath the perforated top surface to facilitate cleaning spills. In accordance with another embodiment, the container support 15 can be movably coupled with the platform 18 such that the container may be vigorously shaken so as to mix the contents of the container. In such an arrangement, the container support 15 can be agitated to induce mixing of the container's ingredients and to improve the dissolution of carbon dioxide into the liquid in the container by oscillating in a transverse direction relative to the top of the platform, oscillating in parallel direction relative to the top of the platform, oscillating at an oblique direction relative to the top of the platform, and/or gyrating or rotating on its axis.

With reference to FIG. 3 of the illustrated arrangement, a chamber 11 is mounted onto the base 10. The chamber surrounds and contains the container 12 and lid 25 during operation of the device. As shown, the chamber 11 can comprise two sidewalls, a back wall, a top, and a cover 16 that can be hinged or otherwise moveably coupled to at least one of the sidewalls, back wall or top. Alternatively, the chamber can be of any suitable geometry. As shown in the embodiment in FIGS. 1-4, the cover 16 may be hinged near the top of the body and open upwards to allow access to the container 12. As shown in FIGS. 1 and 4, the cover can have a first open position for allowing access to the container 12 and container mount 14 and a closed position, as shown in FIG. 3, for preventing such access. The cover 16 may be locked in the closed position during the delivery of carbon dioxide and oscillation of the container 12. The cover 16 reduces the level of noise heard outside of chamber 11. In the illustrated arrangement, the cover 16 is transparent or semi-transparent. FIG. 5 shows an alternative embodiment of a cover, which is hinged on a side.

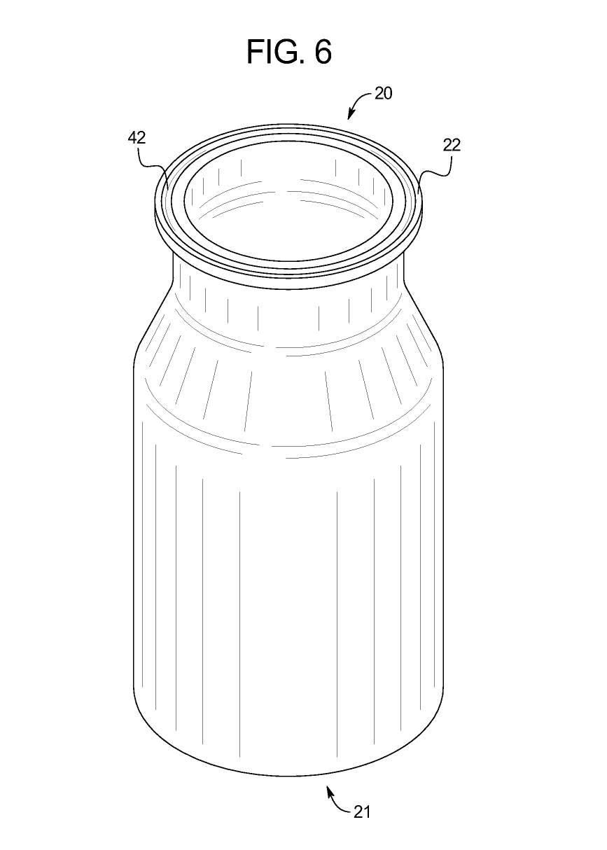

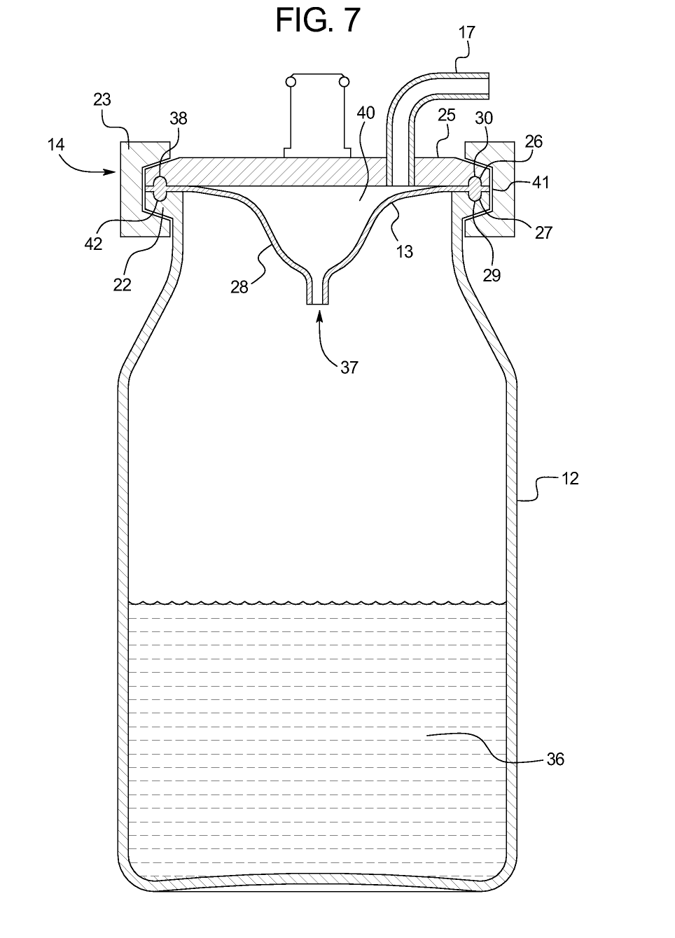

As shown in FIGS. 6 and 7, the container 12 can be a hollow body with a generally cylindrical shape with an open top end 20 and a bottom 21. A mixture of ingredients, which make up a beverage 36 can be placed into the container 12 before the container is mounted into the device 8 for carbonation. During operation, the container is positioned between the platform 18 and the gas supply compartment 40. The distance between the open top end of the container 20 and the bottom 21 can be larger than the largest diameter of the cylindrical shape. The open top end 20 of the container has a rim 22. In certain embodiments, as shown in FIG. 7, rim 22 may also have a groove 42, formed therein. Rim 22 is also sized to receive a gasket 13, which can seal the beverage 36 in the container 12.

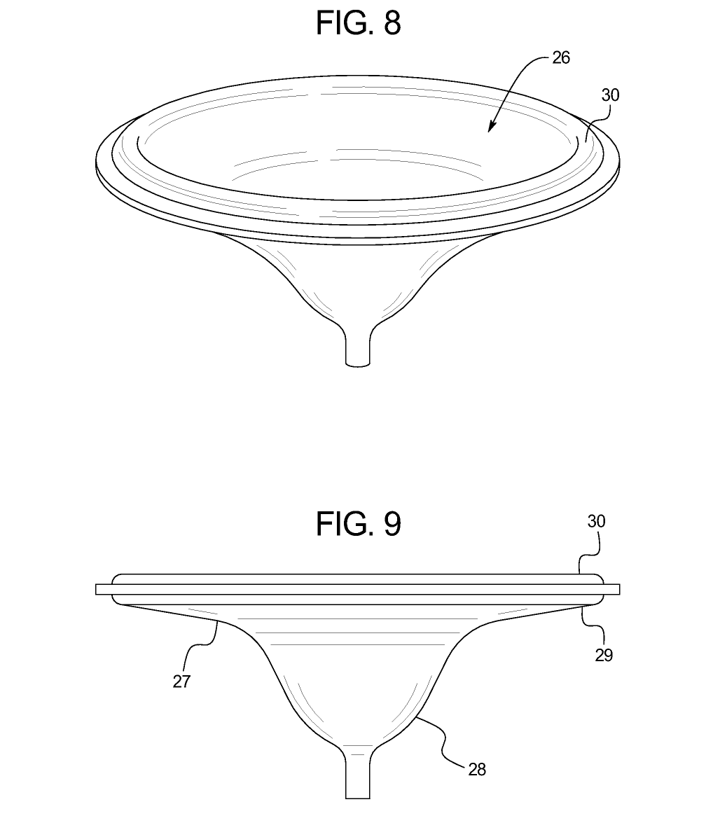

As shown in FIGS. 2 and 8, the container rim 22 is mated with container mount 14, to secure the container 12 to the base 10. With reference to FIG. 2, the container mount 14 is coupled to the base 10 and housed within the chamber 11. The container mount 14 can be movably coupled within chamber 11, such that it can be moved relative to the platform 18 in concert with the container support 15. As shown in FIG. 4, the container mount 14 includes a bracket 23 and a connector 24. The bracket 23 can approximate the curvature of the container 12. As shown in FIG. 7, the interior of the bracket 23 has an annular groove 41, corresponding to the rim 22 of the container 12. A first portion of the bracket 23 is hinged or otherwise moveably coupled to a second portion of the bracket to open such that the mount 14 can receive the container rim 22. The first portion of the bracket interacts with the connector to secure the container 12 onto the container support 15 as shown in FIG. 2. The connector 24 can be comprised of a clasp, screw, bolt, buckler, clip, snap, valve, or other such fastener.

A lid 25 is adjacent the inner diameter of the bracket 23. Lid 25 may be moveably coupled relative to the chamber 11, such the components move in concert with the container support 15 and container mount 14. The lid 25 includes a hole to receive the gas delivery conduit 17, through which supply carbon dioxide gas or other gaseous compound can be delivered.

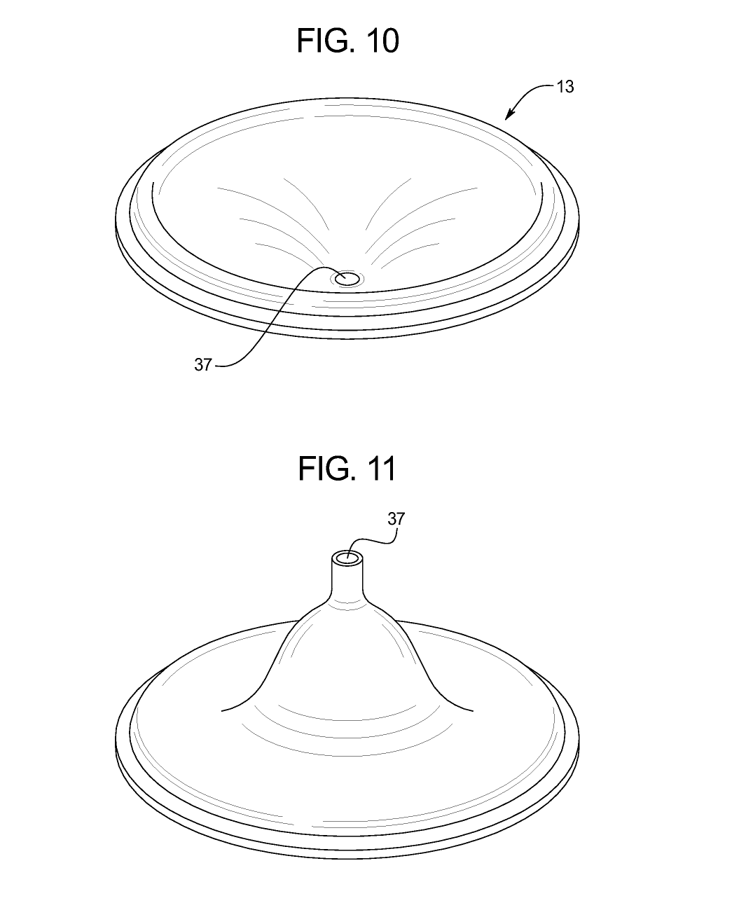

With reference to FIGS. 8-12 the gasket 13 can be circular in shape with a top surface 26 and bottom surface 27 and a frustroconical protrusion 28 through which gas flows into the container 12. In other arrangements, the gasket 13 can have a different shape, for example, to mate with containers of different cross-sectional shapes (not illustrated). The gasket 13 has an outer circumference sized to cover and mate to the container open top end 20. A bottom surface of the gasket 13 is placed on the container open top end 20 and bears resiliently against the rim 22 of the container. In certain embodiments, the outer edge of the bottom surface 27 of the gasket can have a lower lip 29 that mates with rim groove 42. The outer edge of gasket 13 also may abut the annular groove 41 of the bracket 23 of the container mount 14. When viewed from the top, the gasket 13 covers the open top end 20 of the container and seals the container. When mounted to the container 12, gasket 13 prevents the beverage 36 from leaking out of the container 12 or splashing above the rim 22 of the container during carbonation. In one embodiment, the gasket 13 can be comprised of a flexible membrane, polymeric material, silicone material, silicone rubber material and/or elastomeric material. In one embodiment, the gasket 13 is made from a silicone material sold under the brand name Wacker Silicones Elastosil R407/70.

A top side of the gasket 13, opposite the bottom side, couples to the lid 25 by way of the container mount 14. The gasket 13 removably seals to the lid, thereby creating a gas supply compartment 40 between the gasket 13 and the lid 25. The outer edge of the top side of the gasket has an upper lip 30 that is mounted to an inner ring 38 of the lid. In the illustrated embodiment, the gasket 13 has a relaxed and inverted state characterized by the orientation of the frustroconical protrusion 28.

The gasket 13 can be placed on top of the container 12 in its relaxed state with at least a portion of the gasket 13 extending downwardly into the opening of the container 12, as shown in FIG. 8. In one embodiment, during operation, a portion of the gasket 13 may be moved into the inverted state directed away from the opening of the container 13 when gas is supplied into the container 12. In the relaxed state, the frustroconical protrusion 28 comprises two concentric tapering curves.

Gasket 13 has a hole 37 in the frustroconical protrusion 28 thereof, through which the pressurized gas from the gas delivery compartment 40 can flow into container 12. The gasket 13 allows delivery of gas to the container and prevents gas delivery line 17 and lid 25 from becoming contaminated by the beverage. The hole 37 is significantly smaller than the outer diameter of the gasket 13 so as to allow gas to flow through the hole 37, but to prevent the liquid 36 in the container from splashing into the hole 37 and contaminating the gas delivery line 17 and lid 25. Gasket 13 also allows for easier cleaning of the apparatus. It further allows a single apparatus to be used to create a wide variety carbonated beverages, each having different ingredients, so as not to contaminate a new mixture with a previous mixture. Specifically, following operation of the machine to carbonate a beverage with a particular flavor combination, the container 12 and the gasket 13 are removable thus eliminating all remnants of the previous beverage from the apparatus. A clean gasket 13 can be introduced with a clean container 12 once the prior gasket 13 and container 12 are removed from the apparatus. This device thus requires minimal cleaning in between exchange of beverage flavors or differing mixtures. Cleaning the used gasket 13 and container 12 can occur in a separate process, while the machine is operating, allowing for minimal interruption for cleaning between interchange of beverages. This can reduce consumer wait time and prep time. The gasket 13 can also protect the contents of the container 12 from contamination by dirt or debris from outside the container 12. The gasket 13 can also prevent the contents of the container 12 from leaking onto the platform 18 or from splashing onto external device components.

The gasket 13 can also prevent foaming of the carbonated drink while the beverage is contained inside the container during and after the mixing process. During pressurization, the lid 25 and the gasket 13 can form a partial vacuum, coupling the lid 25 to the gasket 13. Also during pressurization, the gasket 13 can be temporarily coupled to the container 12. Once the container 12 is removed from the apparatus, however, the gasket 13 becomes flexibly coupled to the lid 25, from which the gasket 13 may be removed. The gasket 13 is completely removable from the apparatus facilitating rapid replacement of gaskets 13. Relief of pressure from the gas supply compartment relieves the force of the gasket 13 on the rim 22 of the container 12 permitting removal of the container 12 from the device and permitting consumption of the now fully carbonated beverage. The flexibility of the gasket 13 material allows easy removal of the gasket 13 from the lid 25 for cleaning

While in the illustrated embodiment, the gasket 13 inverts or changes shape after pressurization, in other embodiments, the gasket 13 can have a shape that does not substantially change and/or that changes shape in a different manner.

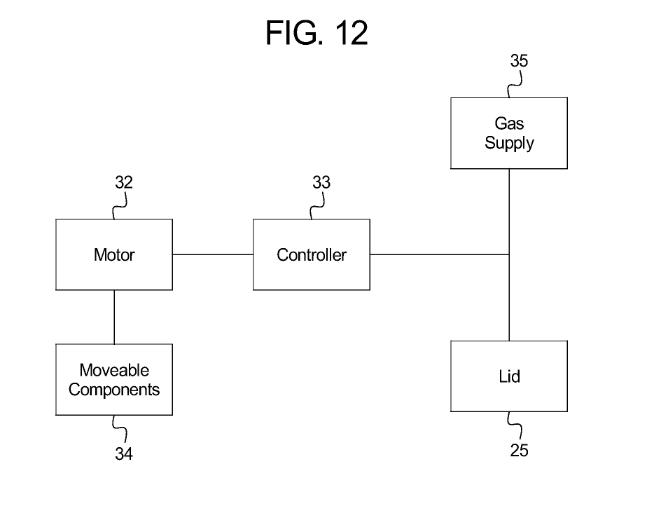

In one embodiment, the base contains an electric motor 32 which is coupled with one or more of the container support 15, container 12, lid 25, and container mount 14 to induce vibration and shaking of the mixture as shown schematically in FIG. 12. The electric motor can be coupled with a motor controller 33, which varies the speed of the vibration and shaking With reference to FIGS. 2 and 3, the base 8 can include motor control buttons 31 which can vary the carbonation level in the mixture by varying the motor oscillation runtime, by varying the intensity of the motor oscillation cycle, and/or by injecting a greater volume of carbonated gas into the container 12, and/or by adjusting the pressure in the container and/or by operating such processes for a different amount of time. The motor control buttons 31 can be manually programmed for a specific runtime, intensity, and volume of gas to be inserted into the mixture and/or pressure for each individual run of the device, or the device can include default programs for preselected mixture combinations.

FIG. 12 shows a schematic drawing of one arrangement the motor and a control device, which can be used in the embodiments of the carbonization device described herein. The motor 32 can be controlled by the controller 33 and can introduce motion in moveable components 34 including one or more of the container support 15, container 12, lid 25, container mount 14, and gas delivery line 17. The controller 33 can also control the supply of gas going from the gas supply 35 through the gas delivery line 17 and into the container 12. For example, in one arrangement, the controller 33 can operate one or more valves positioned along the gas delivery line. The controller 33 can operate the motor 32 and gas supply 35 through independent control and can control both the motor 32 and gas supply simultaneously 35. The controller can vary the presence or absence of gas in the mixture, the flow rate of the gas, the volume of gas to be inserted into the mixture, the amplitude of the vibrations or shaking of the motor, the duration of the duty cycle of the motor and the intensity of the motor's vibrations. Such control can be in response to the user actuating various control buttons, knobs, switches and/or other user inputs provided on the device 8. The controller 33 can be in many forms as is known to those of skill in the art. For example, the controller can comprise a computer control system. The control system can include modules such as a software and/or a hardware component, such as a FPGA or ASIC, which performs certain tasks.

Carbon dioxide gas is introduced into the container 12 via the gas delivery line 17. The pathway of the carbon dioxide gas can travel through the gas delivery line 17, which can be located in a hole in the lid 25, and can enter into the gas supply compartment between the lid 25 and gasket 13 that becomes pressurized by the presence of the flow of gas. The carbon dioxide gas, under pressure, can be forced through the opening in the frustroconical protrusion 28 within the gasket 13 and into the pressure tight vessel with the beverage. The combination of the pressurized gas and mixture can be vigorously shaken to bring the liquid and gaseous particles into intimate contact and aid in dissolving the carbon dioxide into the liquid. The carbon dioxide gas may be supplied from conventional carbon dioxide cylinders to the embodiment. In other arrangements, different gaseous and liquid compounds may be introduced into the mixture through the gas delivery line 17.

One arrangement of using the apparatus comprises partially filling the container 12 with a beverage 36 to be carbonated. This step can include mixing a plurality of ingredients together. The gasket 13 can then be placed in the open end 20 of the container 12 in its relaxed state. The rim 22 of the container can be coupled to the inner lip 29 of the gasket. The container 12 can be placed on the support and the container mount 14 is secured onto the rim 22 of the container 12 with the upper lip of the gasket placed onto the ring 38 of the lid 25. The cover 16 can be placed into the closed position. In one embodiment, the motor 32 commences operation via a motor control button 31. During operation, carbon dioxide gas is introduced into the mixture. The introduction of carbon dioxide gas may occur before the mixture is vigorously agitated on the platform, during agitation, and/or after agitation has completed or some combination or sub-combination. Vigorous agitation can enhance the introduction of carbon dioxide particles into the mixture. The motor 32 can be manually programmed for a specific runtime, intensity, and volume of gas to be inserted into the mixture for each individual run of the device, or alternatively, the device can include default programs for preselected mixture combinations. After agitation is completed, the noise reduction cover can be placed into the open position. The mount 14 can be opened and the container 12 is then removed. The gasket 13 is now coupled to the lid 25 and can be optionally removed for replacement or cleaning The beverage is ready to serve.

The various devices, methods, procedures, and techniques described above provide a number of ways to carry out the described embodiments and arrangements. Of course, not all features, objectives or advantages described are required and/or achieved in accordance with any particular embodiment described herein. Also, although the invention has been disclosed in the context of certain embodiments, arrangements and examples, it will be understood by those skilled in the art that the invention extends beyond the specifically disclosed embodiments to other alternative embodiments, combinations, sub-combinations and/or uses and obvious modifications and equivalents thereof. Accordingly, the invention is not intended to be limited by the specific disclosures of the embodiments herein.

What is claimed is:

1. An apparatus for carbonating beverages comprising:
a base;
a container positioned above at least a portion of the base, the container having a top with an opening and a bottom;
a gasket coupled to the top of the container, the gasket having a funnel-like shape and an opening positioned at a narrow end of the funnel-like shape;
a gas supply compartment above the gasket; and
a gas supply conduit coupled to a gas source and to the gas supply compartment, wherein during operation gas is supplied from the conduit to the gas supply compartment, the gas flows from the gas supply compartment through the opening of the gasket and into to the container.

2. The apparatus of claim 1, wherein at least a portion of the gasket downwardly extends into the opening of the container.

3. The apparatus of claim 2, wherein the gasket has a frustroconical shape.

4. The apparatus of claim 2, wherein at least a portion of the gasket is directed away from the opening of the container during operation when gas is supplied into the container.

5. The apparatus of claim 1, wherein the gasket is removably coupled to the gas supply compartment and the container.

6. The apparatus of claim 1, further comprising a lid removably coupled to the gasket.

7. An apparatus for carbonating beverages comprising:
a gas supply compartment;
a container coupled to the gas supply compartment, the container having an opening;
a gasket coupled to the container and forming a vessel of the container and the gas supply compartment, the gasket having an opening; and
a gas conduit in fluid communication with gas supply compartment.

8. The apparatus of claim 7, wherein the container and gas supply compartment are configured to be shaken while gas is supplied through the gas conduit, into the gas supply compartment, through the gasket hole and into the container.

9. An apparatus for carbonating beverages comprising:
a base;
a lid having a hole;
a gas conduit coupled to the hole in the lid;
a container having an opening; and
a gasket coupled to the container and to the lid to form a vessel, the gasket and the lid defining a gas supply compartment, and the gasket having an opening;
wherein gas flows from the gas conduit into the gas supply compartment, through the gasket hole and into the container.

10. The apparatus of claim 9, wherein the gasket has a frustroconical shape.

11. The apparatus of claim 9, wherein the gasket is removably coupled to the lid and the container.

12. The apparatus of claim 9, wherein the container abuts the bottom surface of the gasket and the lid abuts the top surface of the gasket.

13. The apparatus of claim 9, wherein the gasket opening is not aligned with the hole in the lid.

14. The apparatus of claim 9, further comprising a mount removably securing the lid and the container to the base.

15. The apparatus of claim 14, wherein the mount comprises a bracket having an annular groove coupled to the lid and the container.

16. The apparatus of claim 14, further comprising a motor coupled to the mount and the lid to induce movement of the container when the container is secured within the mount.

17. The apparatus of claim 16, further comprising a container support upon which the bottom of the container rests, wherein the container support moves in concert with the mount and the lid when movement is induced by the motor.

18. The apparatus of claim 14, further comprising:
a container support upon which the bottom of the container rests; and
a motor coupled to the container support to induce movement of the container when the container is secured within the mount.

19. The apparatus of claim 9, further comprising:
a chamber surrounding the container and the lid; and
a cover movably connected to the base, wherein the cover is movable from a first open position which allows access to the container to a second closed position, which prevents access to the container.

20. A method of carbonating a beverage comprising:
filling a container with a liquid;
placing a gasket on an opening of the container;
coupling the container and the gasket to a gas supply compartment of a carbonation device; and
actuating the carbonation device to supply gas into the gas supply compartment, wherein the gas flows from the gas supply compartment through a gasket hole and into the container.

21. The method of claim 20, further comprising actuating the carbonation device to shake the container.

22. The method of claim 21, wherein gas is supplied through the gasket and into the container while the carbonation device is shaken.

23. A method of carbonating a beverage comprising:
filling a container with a liquid;
placing a gasket between an opening of the container and a gas supply compartment of a carbonation device;
supplying gas into the gas supply compartment, wherein the gas flows from the gas supply compartment, through the gasket and into the container.

24. The method of claim 23, further comprising shaking the container while gas is supplied through the gasket and into the container.

25. A method of carbonating a beverage comprising; shaking a container comprising a plurality of ingredients while carbon dioxide gas is supplied through an opening in a gasket positioned on an opening of the container.

26. The method of claim 25, further comprising supplying gas through a gas supply compartment and then through the gasket and into the container.

27. The method of claim 26, further comprising converting the gasket from a first configuration to a second configuration as gas is supplied through the gas supply compartment and into the container.
